(19) United States
(12) Patent Application Publication
(10) Pub. No.: US 2004/0172351 A1
(43) Pub. Date: Sep. 2, 2004

(54) Method and computer program product for processing and awarding a grant

(75) Inventors: Thomas A. Luntz, Highland Beach, FL (US); Stephen D. Marcus, Deerfield Beach, FL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FAMILIA DONUM, LLC., Deerfield Beach, FL

(21) Appl. No.: 10/373,775

(22) Filed: Feb. 27, 2003

(51) Int. Cl. G06F 17/60

(52) U.S. Cl. 705/35

(57) ABSTRACT

A method for awarding a grant to a seller to help a buyer in which the grant is from a charitable contribution made by a donor to a pool of funds of a nonprofit organization. The donor donates an amount of money which is not capped to the nonprofit organization with an intention to help the buyer to buy a house. The donor qualifies for a tax break from IRS for the money donated to the nonprofit organization. The seller of the house receives directly a gift from the nonprofit organization equal to the amount donated by the donor minus a fee retained by the nonprofit organization. The gift received by the seller from the organization is equivalent to a down payment made in behalf of the buyer. The remaining money to the full price of the house is obtained by the buyer from a lender. Based on information sent by the nonprofit organization to a closing agent regarding disbursement of the down payment for the house to the seller from the organization, the buyer qualifies for the mortgage loan without paying the down payment for the house.

### BACKGROUND OF THE INVENTION

1. Field of the Invention

The present invention relates to a method and computer program product for awarding a grant by an organization to an entity that applies for such grant that is accommodated by a donation from individuals/corporations sufficient to provide the grant.

2. Description of the Related Art

As is evident from the present tax code, there is a compelling social interest for a variety of people to buy houses instead of renting them. Owning property instills a motivation to maintain and protect, rather than disregard property. More specifically, the owner of a house accumulates equity each month when making payments to the mortgage company instead of wasting that money on paying the rent to the landlord. In addition, the owner of the house builds a credit history over a long period of time that improves his credit worthiness. Owning a house creates a feeling of accomplishment and belonging that more than offsets the higher cost of mortgage payments over rent.

However, many families or individuals have decent credit and means to pay a mortgage, but cannot save enough to pay the down payment for the house. Therefore, these persons are denied or delayed the opportunity to own a house. A typical down payment for a house is usually quite a bit more than a monthly mortgage payment, and so the down payment is a difficult obstacle for many would-be house buyers.

As a response to this problem, several assistance programs have emerged that help buyers make their down payments. Governmental assistance programs are available at the Federal, state and municipal levels. For example, the Department of Housing and Urban Development offers a down payment assistance program to people who qualify for a revolving loan to be used for the down payment. However, to qualify for these programs, the buyer must have an income lower than a certain threshold while still satisfying other financial and credit criteria. The combination of low income and adequate financial and credit worthiness greatly limits the accessibility of such programs to many people.

A private program, the Nehemiah Program, run by a nonprofit organization appeared a few years ago to assist buyers in buying a house for a reduced down payment. In this program, a nonprofit organization collects gifts from various house sellers and then distributes these gifts to buyers as the down payment for buying respective of the sellers' houses. FIG. 1 is a diagram illustrating the process of donating money by the sellers to the organization, which in turn grants the money to a beneficiary, which in this case is the lender of a mortgage for a home-purchaser. More specifically, the seller 10 gifts a predetermined amount of money (say 10% of a purchase price of a home) to the organization 20. By making the donation, the seller is entitled to a tax deduction from the IRS 40 for making the charitable contribution to the organization 20. The organization 20 then assists the beneficiary 30, the buyer (or more specifically the buyer's lender), with the down payment by matching the gift received from the seller 10. Therefore, the beneficiary 30 overcomes the problem of making a big down payment for the house when the beneficiary 30 does not have that amount of money available.

The organization retains a participation fee from the gift donated by the seller 10, usually a few hundred dollars. Under the program requirements, the buyer does not receive the down payment nor any other funds from the seller, a step that would violate most lenders' guidelines. Instead, the seller gives the money to the Nehemiah Program (organization 20), which in turn gives money from its pool of funds to the buyer for the down payment, as requested by the seller. These steps conform with the guidelines of many lenders, including the Federal Housing Administration, which allows buyers to accept gifts from nonprofit groups. The benefit to buyers is obvious: they can buy a house months or years earlier than if they had to wait until they were able to put together several thousand dollars for the down payment.

For this program to work, there has to be a benefit for sellers too. Sellers or builders who participate in this program can advertise that their house is available for no money down and this kind of participation can make a house more marketable, perhaps the most attractive in a particular neighborhood or subdivision. It may be particularly advantageous for homeowners who need to sell as quickly as possible, regardless of market conditions. It can also be a help for sellers in slow markets or in a neighborhood with identical houses whereas it is difficult to distinguish one house from another.

However, in spite of the above advantages of the Nehemiah Program, a few major disadvantages characterize this and other programs. First, the home buyer must have at least 1% of the house sales price, which is also known as a “reserve” or “bank reserves.” Therefore, the buyer still has to make a small down payment. Another disadvantage of this program is that the seller must agree to make a 3% contribution to the Nehemiah Corporation. Therefore, the seller does not get the full price of the house. In real terms, the seller gets about 97% of the full price of the house.

A similar program is run by the A New Horizon (ANH) organization, which is a “501(C)(3)” nonprofit organization, referring to Title 26, section 501(C)(3) of the United States Code (26 USC 501(C)(3)), the entire contents of which is incorporated herein by reference. ANH offers a down payment assistance program to individuals. In more detail, the program used by ANH is illustrated in FIG. 2, in which the seller 10 must sign an agreement with the organization 20 to gift 5% of the full house price to the organization 20. For this donation, the seller 10 qualifies for a tax break from IRS 40. The money received by the organization 20 from the seller 10 is added to a pool of funds. ANH, at its own discretion, uses money from the pool of funds as a down payment for the house purchased by the buyer 30. The buyer 30 requests a mortgage from a bank 60 for an amount equal to the full price of the house less the amount donated by the seller 10 to the organization 20. The mortgage (95% of the full price of the house) taken by the buyer 30 from the bank 60 together with the down payment (5% of the full house price) received by the buyer 30 from the organization 20 go to the seller 10 in exchange for the seller's house.

The down payment assistance program offered by ANH has the disadvantage that the seller must commit a certain percentage of the full house price as a gift to the organization 20. Therefore, in real terms, the seller 10 does not get the full price of the house.

FIG. 3 is a flow chart illustrating the steps of the down payment assistance program of ANH through which the seller gifts money to the organization and in return gets a tax break from the IRS. More specifically, in step 301, the seller puts the house on the market and the potential buyers are made aware that a down payment program is available for that house from the organization. In step 303 the organization provides (or promises) the funds necessary for the down payment to a buyer who buys the house from the seller. Further, in step 305 (which may occur at the same time as, or before, step 303), the buyer requests a mortgage from a bank (or, more generally, “lender”) for the remaining amount of money necessary for buying the house from the seller. Based on information provided by the organization, the bank awards the mortgage to the buyer and provides the funds to the seller for the house in step 307. Then, in step 309, the seller agrees with the organization to gift the organization a certain percentage of the full price of the house at the time of the settlement. In step 311, the seller receives the full price of the house but then gifts to the organization an amount equal to the down payment of the house. Therefore, in net terms, the seller does not get the full price of the house. Finally, in step 313, the seller gets a tax break from IRS for the funds gifted to the organization.

For a better appreciation of the nature of such an organization, a brief description of the features, requirements-on, and attributes of such an organization is in order.

To be tax-exempt as an organization described in IRC (Internal Revenue Code) Section 501(c)(3) of the Code, an organization must be organized and operated exclusively for one or more of the purposes set forth in IRC Section 501(c)(3) and none of the earnings of the organization may inure to any private shareholder or individual. In addition, it may not attempt to influence legislation as a substantial part of its activities and it may not participate at all in campaign activity for or against political candidates.

The organizations described in IRC Section 501(c)(3) are commonly referred to under the general heading of “charitable organizations.” Organizations described in IRC Section 501(c)(3), other than testing for public safety organizations, are eligible to receive tax-deductible contributions in accordance with IRC Section 170.

The exempt purposes set forth in IRC Section 501(c)(3) are charitable, religious, educational, scientific, literary, testing for public safety, fostering national or international amateur sports competition, and the prevention of cruelty to children or animals. The term charitable is used in its generally accepted legal sense and includes relief of the poor, the distressed, or the underprivileged; advancement of religion; advancement of education or science; erection or maintenance of public buildings, monuments, or works; lessening the burdens of government; lessening of neighborhood tensions; elimination of prejudice and discrimination; defense of human and civil rights secured by law; and combating community deterioration and juvenile delinquency.

To be organized exclusively for a charitable purpose, the organization must be a corporation, community chest, fund, or foundation. A charitable trust is a fund or foundation and will qualify. However, an individual or a partnership will not qualify. The articles of organization must limit the organization's purposes to one or more of the exempt purposes set forth in IRC Section 501(c)(3) and must not expressly empower it to engage, other than as an insubstantial part of its activities, in activities that are not in furtherance of one or more of those purposes. This requirement may be met if the purposes stated in the articles of organization are limited in some way by reference to IRC Section 501(c)(3). In addition, assets of an organization must be permanently dedicated to an exempt purpose. This means that should an organization dissolve, its assets must be distributed for an exempt purpose described in this chapter, or to the federal government or to a state or local government for a public purpose. To establish that an organization's assets will be permanently dedicated to an exempt purpose, the articles of organization should contain a provision insuring their distribution for an exempt purpose in the event of dissolution. Although reliance may be placed upon state law to establish permanent dedication of assets for exempt purposes, an organization's application can be processed by the IRS more rapidly if its articles of organization include a provision insuring permanent dedication of assets for exempt purposes.

An organization is regarded as “operated exclusively” for one or more exempt purposes only if it engages primarily in activities which accomplish one or more of the exempt purposes specified in IRC Section 501(c)(3). An organization will not be so regarded if more than an insubstantial part of its activities is not in furtherance of an exempt purpose. More information concerning types of charitable organizations and their activities, is available in IRS Publication 557.

The organization must not be organized or operated for the benefit of private interests, such as the creator or the creator's family, shareholders of the organization, other designated individuals, or persons controlled directly or indirectly by such private interests. No part of the net earnings of an IRC Section 501(c)(3) organization may inure to the benefit of any private shareholder or individual. A private shareholder or individual is a person having a personal and private interest in the activities of the organization. If the organization engages in an excess benefit transaction with a person having substantial influence over the organization, an excise tax may be imposed on the person and any managers agreeing to the transaction.

An IRC Section 501(c)(3) organization may not engage in carrying on propaganda, or otherwise attempting, to influence legislation as a substantial part of its activities. Whether an organization has attempted to influence legislation as a substantial part of its activities is determined based upon all relevant facts and circumstances. However, most IRC Section 501(c)(3) organizations may use Form 5768, Election/Revocation of Election by an Eligible Section 501(c) (3) Organization to Make Expenditures to Influence Legislation, to make an election under IRC Section 501 (h) to be subject to an objectively measured expenditure test with respect to lobbying activities rather than the less precise “substantial activity” test. Electing organizations are subject to tax on lobbying activities that exceed a specified percentage of their exempt function expenditures.

For purposes of IRC Section 501(c)(3), legislative activities and political activities are two different things, and are subject to two different sets of rules. The latter is an absolute bar. An IRC Section 501(c)(3) organization may not participate in, or intervene in (including the publishing or distributing of statements), any political campaign on behalf of (or in opposition to) any candidate for public office. Whether an organization is engaging in prohibited political campaign activity depends upon all the facts and circumstances in each case. For example, organizations may sponsor debates or forums to educate voters. But if the forum or debate shows a preference for or against a certain candidate, it becomes a prohibited activity. The motivation of an organization is not relevant in determining whether the political campaign prohibition has been violated. Activities that encourage people to vote for or against a particular candidate, even on the basis of non-partisan criteria, violate the political campaign prohibition of IRC Section 501(c)(3).

### SUMMARY OF THE INVENTION

An exemplary embodiment of the present invention provides a method for coordinating a tax-deductible donation from a third-party donor to a non-profit organization, which in turn gifts funds to a seller of a property (e.g., house), or offers another service such a private education, as partial payment for the property (or service) obtained by a buyer (or more generally, beneficiary). This method offers the advantage of enabling the seller to obtain the full fair market value of the house, without having to contribute any funds to the organization. In addition, the buyer benefits from gifts from a non-profit organization, which in turn were donated to the organization from a third-party donor. The money from the third-party donor is viewed by the IRS as a tax-deductible donation, and also is not subject to a gift tax. Thus, the full benefit of the donation is conveyed to the buyer, and the donor is rewarded with a tax-deduction for their contribution. This method also benefits governmental and societal interests in that it helps more people own their own home, obtain a private education, assist with senior care or other service that has a compelling societal interest.

In accordance with another aspect of the invention, a donor donates funds to the organization, and the donor receives a tax deduction from the IRS for the donation given to the organization. Consequently, the organization gifts funds to an entity, which is not the donor, and the entity uses the funds received from the organization to reduce various debts for a house, a tuition loan, payment of an automobile, medical bills, assisted care, private education, and small business administration. Further, the amount of the donation given by the donor to the organization is fully tax deductible and it is not capped, subject to an individual's or a corporation's adjusted gross income limitations for charitable deductions on an income tax return.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a program practiced by Nehemiah Corporation;

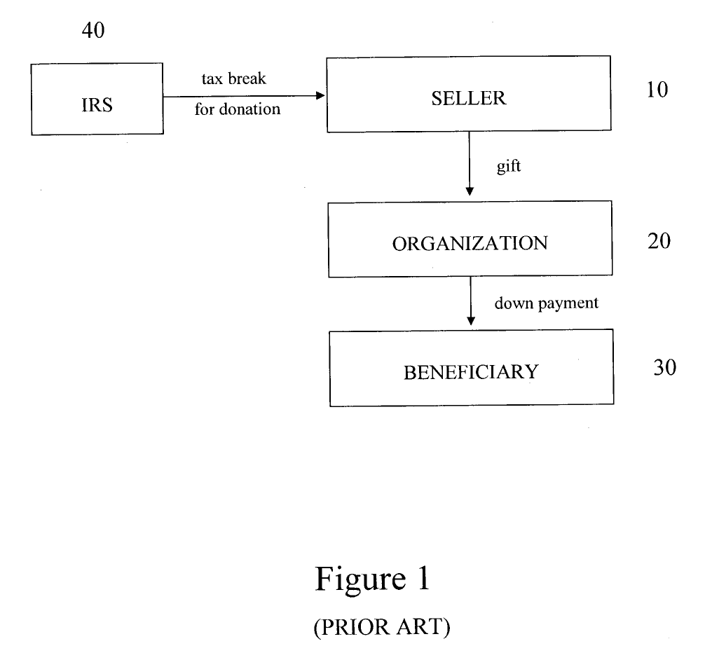

FIG. 2 is a block diagram of a down payment assistance program used by A New Horizon nonprofit organization;

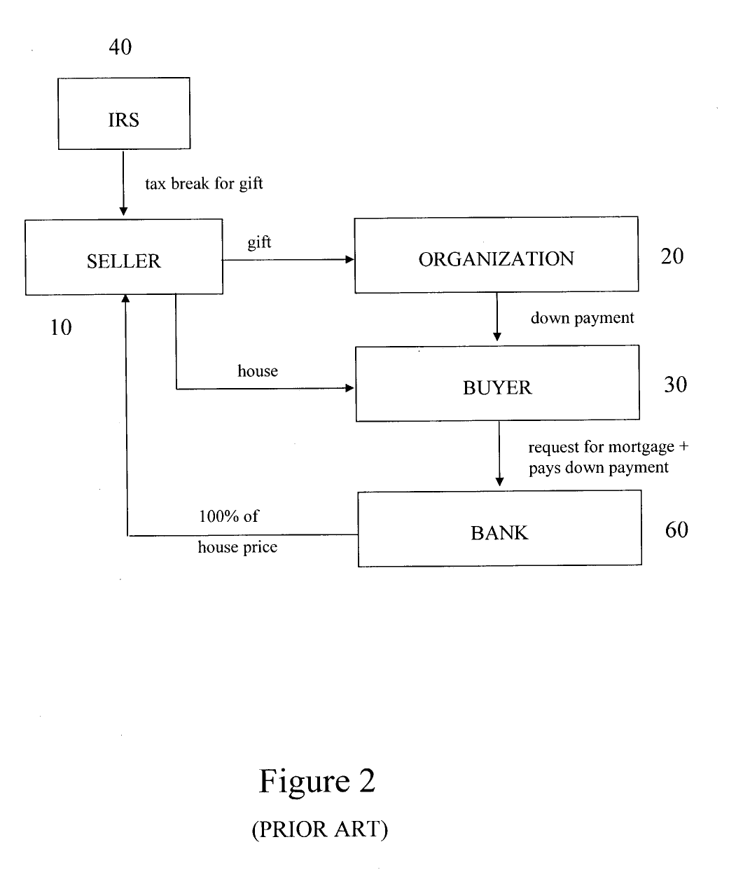

FIG. 3 is a flow chart depicting a method to award a down payment to a buyer from an organization;

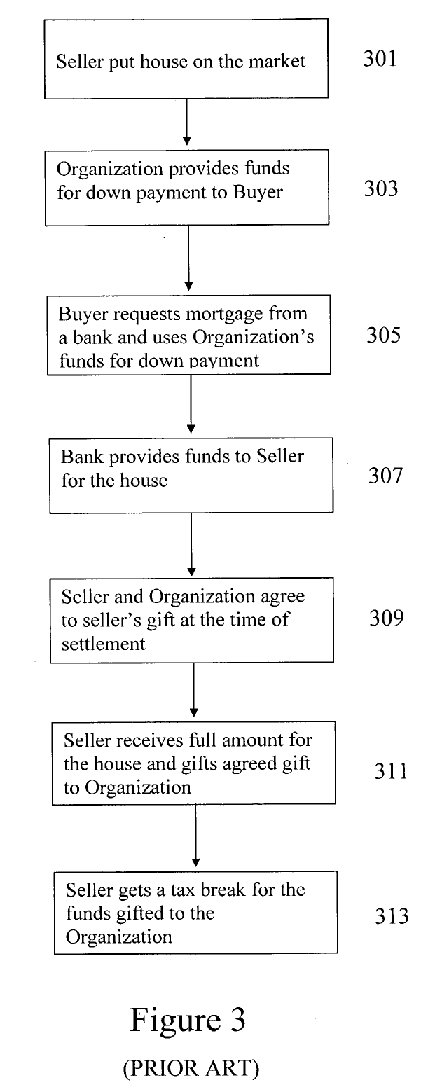

FIG. 4 is a block diagram of a method for awarding a grant in accordance with an exemplary embodiment of the invention;

FIG. 5 is a flow chart illustrating the overall process for awarding a grant to a seller from the organization;

FIG. 6 is a block diagram of a general debt management program of the present invention; and

FIG. 7 is a flow chart illustrating the flow of money from a donor through an organization to an entity in another exemplary embodiment of this invention.

### DETAILED DESCRIPTION OF THE INVENTION

Certain terminology used in the following description is for convenience only and is not intended to limit the scope of the invention as claimed. In the drawings, the same reference numerals are used for designating the same elements throughout the several figures.

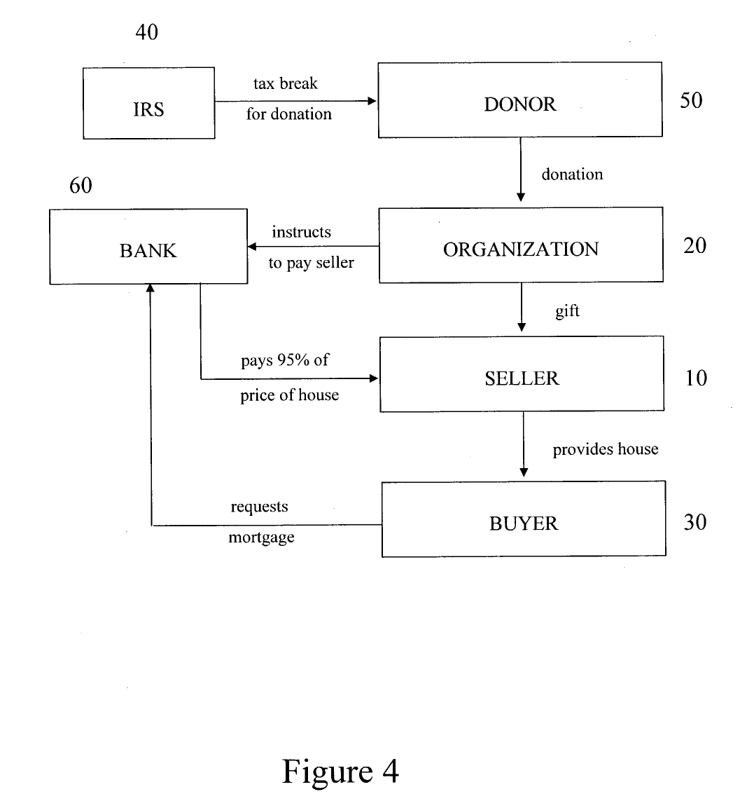

FIG. 4 is a block diagram illustrating a debt assistance program in which a seller receives a gift from an organization in accordance with an exemplary embodiment of the invention. The organization 20 is a 501(C)(3) nonprofit organization in this embodiment, but the organization 20 is not limited only to this type of nonprofit organization, if the Internal Revenue Code is changed in the future to permit other organizations to perform the function of a 501(C)(3) organization, as described herein.

The organization 20 receives a donation from a donor 50. The donor 50 optionally may choose to donate the money and designate a class of people (but not a specific individual). Also, the donor might encourage a person (e.g. a candidate buyer) to participate in the programs offered by the organization 20 (for example to buy a house from a list of properties compiled by the organization 20). All donations are charitable contributions, and therefore tax deductible to the donor, form a pool of funds administered by the organization 20. A predetermined portion of the donation provided by the donor 50 is retained by the organization 20 as a fee. The fee could account for as a separate payment by the donor, a donation from the ultimately third-party beneficiary (buyer 30), or perhaps investment returns that accrue during the period of time the organization 20 has the money.

A seller 10 who wants to sell his house for a certain price applies to the organization 20 for a grant and receives a portion of the house price as a gift equal to a certain percentage of the full house price. When the seller 10 applies for the grant to the organization 20, the seller agrees to include the property on the list of properties that qualify for gifts from organization 20. Once a buyer 30 is found for the seller's property, the buyer 30 and seller 10 enter into an agreement for the transfer of the property rights. The organization 20 determines whether a portion of the pooled funds managed by the organization 20 should be made available as a gift to the seller 10 for the benefit of the buyer 30. The organization 20 decides to gift the funds to seller 10 at its own discretion, based upon an established criteria. The organization may also opt to donate certain funds to buyers that meet certain criteria. For example, funds may have been donated with an expressed suggestion or a request that the money be used to help minorities, or perhaps single mothers. If the funds are donated with an expressed suggestion, the organization would have the option to use those funds for a selected set of buyers. If the funds are donated with a stipulation that these funds must be directed to a certain class of people (not a specific individual nor a class of people that could only be a specific person), the organization must follow the stipulation. Otherwise, the donation should be returned to the donor.

After the buyer 30 decides to buy the house, the buyer 30 applies for a mortgage loan to a bank 60, even if the buyer 30 does not have the money for a down payment, and therefore does not qualify for a mortgage loan from the bank 60 under normal conditions. However, the organization 20 informs the bank 60 (or more generally “lender”) that the down payment amount for the transaction between the buyer 30 and the seller 10 will be gifted by the organization 20 directly to the seller 10 at settlement. Under these circumstances, the bank 60 awards the mortgage loan to the buyer 30, and pays to the seller 10 an amount equal to a difference between the full price of the house asked by the seller 10 and the gift received by the seller 10 from the organization 20. Under these circumstances, the seller 10 receives the full price of the house without donating or gifting any amount of money to the organization 20, and the buyer 30 is able to buy the house from the seller 10 with no down payment due to the gift provided by the donor 50 to the organization 20. Likewise, the donor 50 has the moral satisfaction that he helped a buyer get into the house, while receiving a tax donation for the charitable contribution. Society as a whole benefits because more people become homeowners, which is the policy used to justify why homeowners are allowed to deduct interest on their mortgage payments and points paid on a first mortgage, but renters receive no equivalent break.

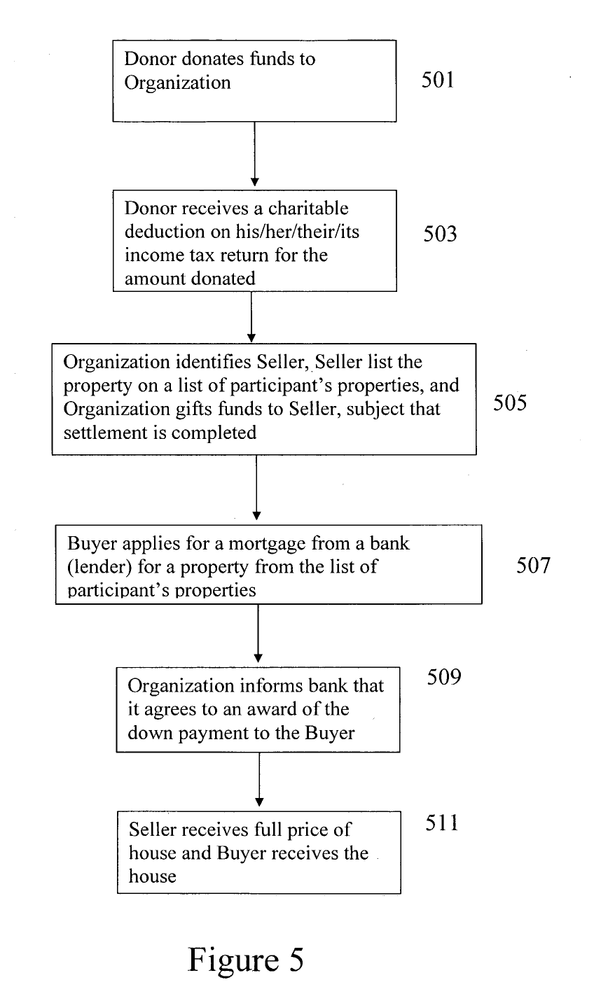

FIG. 5 is a flow chart illustrating the steps taken by various parties involved in the sale of the house, the seller 10, the buyer 30, the donor 50, the organization 20, and the bank 60. In step 501 the donor 50 donates funds to the organization 20. In step 503, the donor 50 receives a tax break from the IRS for the donation made to the organization 20. The donation given by the donor 50 to the organization 20 is not limited by gift tax exemptions because it is a charitable gift, and thus fully qualifies for the tax break from IRS 40. In step 505, the organization 20 receives a grant application form from the seller 10 in which the seller 10 requests a grant and agrees to list the property on a list of participating properties. The organization then gifts the funds to the seller, or provides a gift letter to be fulfilled at time of settlement. The size of the donation could be, but need not be, more or less than the downpayment required by the lender. Subsequently, the organization 20 informs the bank 60 of the gift, at which time the buyer 30 applied for the mortgage loan (step 507), the down payment for the loan being satisfied by the gift or promise of a gift to the seller 10 from the organization 20 for the benefit of the buyer 30. In step 509, the organization 20 informs the bank 60 that it agrees to an award of the mortgage to the buyer 30. Finally, at settlement, in step 511, the seller 10 receives the full price of the house, and the buyer 30 receives the house without the down payment. If the organization 20 only provided a gift letter in step 505, the organization actually gifts the money to seller at settlement.

In this process, the organization 20 does not have an interaction directly with the buyer 30 and does not disburse any amount of money to the buyer 30. Thus, there is no direct gift given to the buyer 30 in the eventuality that the transaction between the seller 10 and the buyer 30 falls apart. Further, the organization 20 disburses the down payment of the house directly to the seller 10 at its own discretion, if the transaction between the seller and buyer is completed, and therefore avoids recovering money from the buyer in the eventuality that the closing does not take place. Further, the seller 10 receives the full price of the house, part from the organization 20 and part as a cheque from the bank 60. In addition, the seller 10 does not have to commit any funds to the organization 20 or to the bank 60 in exchange for selling the house to the buyer 30. The decision on whether, and how, to allocate gifts based on the source of the donations received is that of the organization to make in its sole and absolute discretion provided the exempt purpose and mission of the organization is adhered to.

Moreover, many buyers who do not have enough funds to provide the down payment to qualify for a mortgage loan under normal circumstances, under this process, have the opportunity to buy a house without the down payment based on donations given by donors to the organization.

### EXAMPLE

An example process of selling a house and getting a gift from the organization is now illustrated in the following practical example. Initially, the donor signs a donation form in which he pledges a certain amount of money, the donation, to the organization. The donation form does not include any reference to the seller, the buyer, or any other entity, as required by IRS rules. The donation pledged in the donation form goes to a pool of funds managed by the organization. The pool of funds is available for gifts to persons who apply for a gift.

The seller of a property agrees with the organization to list his property on a list of properties that qualify for gifts from the organization. Then, the seller applies for a gift from the organization by signing a gift request form in which the seller requests a gift for selling the property. The gift request form identifies the property to be sold.

The buyer of the property enters into an agreement with the seller of the property that the seller will receive the full price of the house, part from the buyer and part from the organization.

At this stage, the closing agent who handles the transaction between the seller and the buyer receives all the forms signed by the buyer, seller, and also the donation forms from the organization. The closing agent, which coordinates all aspects of the transaction, instructs the lender and the organization to disburse the loan and the gift, respectively, at the closing. Awarding grants from donated funds to benefit certain sellers/buyers is a function performed by the organization, as it sees fit.

Some of the advantages of the debt management program of gifting funds directly to the seller and not to the buyer, as in the previous schemes, are the following:

a) candidate sellers may prefer to sell their property to pay off credit cards, or discharge other debts. The sale of property under stress causes the seller to fall short of anticipated equity that could be used to pay off such debt. The present debt management program, by gifting funds directly to the seller, most likely the seller would be able to generate sufficient proceeds from the sale of the property so that the seller could then pay off the debts;

b) candidate sellers may prefer to sell their property to pay delinquent IRS taxes. The sale of property under stress causes the sellers to fall short of anticipated equity that could be used to pay off IRS taxes, liens and/or judgments. The present debt management program by gifting funds directly to the seller, most likely the seller would be able to generate sufficient proceeds from the sale of the property to pay off creditors; and

c) candidate sellers may prefer to sell their property to forestall foreclosure from a bank. The sale of foreclosure properties under stress always robs the seller of any equity that could be generated as the result of the sale of the home. In addition, the typical buyer of the “stressed property” which is in foreclosure is usually financially strong enough to “beat down” the price of the home to the lenders' sale threshold with no regard whatsoever for the seller's equity or assets. Receiving the gift from the present debt management program, the seller would not be thrown out of the home, as a result of the foreclosure.

By providing support for buyers who cannot afford a down payment of a house, an important share of the buyer market is provided with an opportunity to buy houses resulting in (i) increased business for banks and mortgage lenders, and (ii) more home owners. In this novel debt management program, the buyer does not pay any fee to the organization for gifting the down payment to the seller. Also, the charitable contribution of the donor to the organization does not have a cap and the charitable contribution is fully tax deductible subject to an individual's or a corporation's adjusted gross income limitations for charitable deductions on an income tax return.

The new homeowner has no tax obligation, enjoys the benefit of the individual's or corporations' benevolent act and gets a home without the down payment. The donor receives a tax deduction for the donation and a donation greater than $11,000 is allowed to be given to the organization. In addition, the seller receives the full asking price for the house.

In another embodiment, if the seller is looking for a new home in the next 12 months after the seller sold the house, the seller can take all or a portion of the equity and donate it to the present debt management program. This allows the seller to earn a tax deduction corresponding to the amount donated to the present debt management program and the donated funds are then put into the pool of funds for down payment assistance funds. The seller, now the buyer, eventually selects a new home in the 12 months period and then the present debt management program forwards funds to the closing office on behalf of the next seller. The gift to the seller is not taxable. Therefore, the buyer (previous seller), automatically gets an equity into the new house he purchases and also gets a tax deduction for the amount donated to the organization when he sold the previous house.

In yet another embodiment, the present debt management program offers a more general approach to gifting money from a nonprofit organization to a beneficiary not only for house-related transactions, but also pertinent to any debt owned by the beneficiary to an entity.

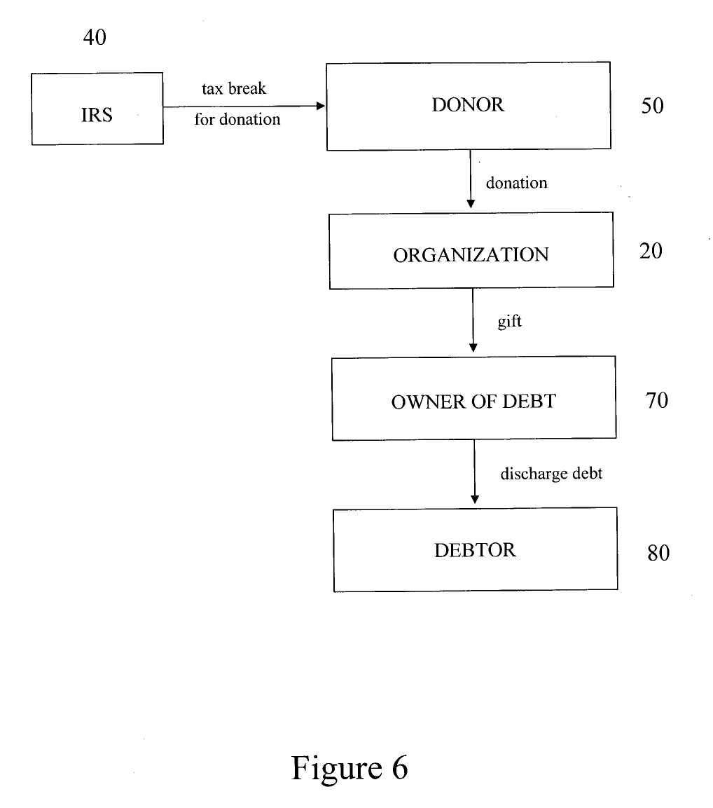

FIG. 6 is a schematic diagram of a general debt management program of the present invention in which a donor 50 donates funds to an organization 20. The donor 50 qualifies for a charitable contribution from the IRS 40 for the donation given to the organization 20. Subsequently, the organization 20 gifts to the owner of a debt 70 a grant in an amount that matches, or is less than, but does not exceed, the donation of the donor 50, such that the owner 70 discharges all or part of a debt of the debtor 80. Such debts may be past loans, etc. In a separate embodiment, the donor takes a loan, or accepts a debt, from the organization to make funds available for gifting.

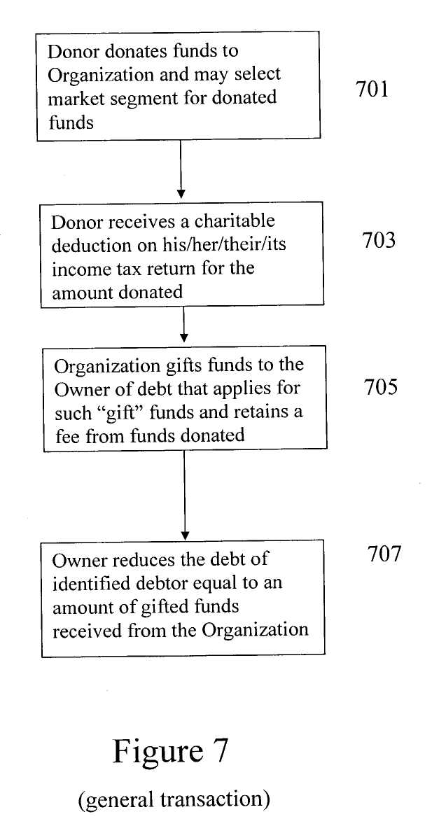

The general debt management program starts with step 701, illustrated in FIG. 7, in which the donor donates funds to the organization and may select market segments for the donated funds. This “market segments” feature is to address the fact that the financial obligation may be for a variety of purposes, such as to reduce various debts for a house, a tuition loan, payment for an automobile, medical bills, assisted care, private education tuition (including elementary through college, or professional school), and small business administration loans or debts incurred for the purpose of starting a small business.

In the following step 703, the donor receives a charitable deduction from the IRS for the donation. Further, in step 705 the organization retains a fee from the funds donated and gifts the funds to the owner of the debt that applies for such “gift funds,” and in step 707, the owner discharges all or a part of the debt of the identified debtor in an amount equal to or less than an amount of the gifted funds received by the organization. In this embodiment, the debt of the debtor may be any one of, but not limited to, a bank loan, medical institution bills, an education institution loan, and small business administration taxes. The organization chooses the gift recipient in a manner consistent with the previously described embodiments.

### EXAMPLE FOR PRIVATE SCHOOL TUITION ASSISTANCE

The following is a practical example for assisting a student with school tuition. A student that needs help paying for tuition or other school related expenses and fees for his private school registers with the organization and obtains an account in exchange for a fee. The organization provides to the student free training sessions of how to manage tuition loans, and in general finances. Then, the student signs an application form addressed to the organization in which the student requests a certain amount to be disbursed to the private school. Consequently, the school applies to the organization for a gift that is equal or less in value than the tuition fee for the student. Independent of these actions, a donor signs a donation form in which the donor agrees to donate a certain amount of money to a pool of funds of the organization for helping a school, and this money is tax deductible for the donor. Consequently, the donor donates the money in the pool of fund of the organization. Having all this information, when the organization receives the request for a gift from the school for the student, the organization evaluates various potential donations and awards a grant to a school if enough funds are available. The organization decides to disburse the money to the school once confirming that the beneficiary is a qualified program participant. Then, the organization disburses the grant to the school for the benefit of the student.

The method of the debt management program described in this embodiment has the advantage that any organization or person can help a person in debt or a person willing to assume a debt, through a nonprofit organization with an amount of money which is not capped by a gift tax. The person who helps the person in debt qualifies for a tax deduction from the IRS for the amount of money donated to the organization. The person in debt does not receive directly the money from the nonprofit organization but rather an entity that owns the debt of the person intended to be assisted receives the money directly from the pool of funds of the nonprofit organization. Therefore, the owner of the debt reduces the debt of the debtor with an amount equal to the gift received from the nonprofit organization.

Accordingly, this novel debt management program does not disburse money directly to the person having a debt, preventing fraud or misuse of money which were earmarked for reducing a certain debt. The nonprofit organization disburses a grant directly to the entity that owns the debt of the beneficiary, making sure that the debt is reduced by an amount equal to the gift. Therefore, the beneficiary is helped either to acquire a house or to reduce an existing debt.

Obviously, discernible modifications and variations of the present invention are possible in light of the above teachings. It is therefore to be understood that within the scope of the appended claims, the invention may be practiced otherwise than as specifically described herein. For example, while described in terms of various entities interactively cooperating, it is contemplated that the problem described herein may be practiced using computers and digital communications.

Thus, the foregoing discussion discloses and describes merely exemplary embodiments of the present invention. As will be understood by those skilled in the art, the present invention may be embodied in other specific forms without departing from the spirit of essential characteristics thereof. Accordingly, the disclosure of the present invention is intended to be illustrative, but not limiting of the scope of the invention, as well as other claims. The disclosure, including any readily discernible variance of the teachings herein, defines, in part, the scope of the foregoing claim terminology such that no inventive subject matter is dedicated to the public.

Claims:

1. A method for awarding a grant, comprising:
forming a pool of funds from a charitable donation made by funds from a donor and other charitable donations by other donors;
receiving a disbursement request from an entity for the grant;
retrieving information about the funds donated by the donor;
appropriating funds included in the pool of funds to the grant; and
awarding the grant to the entity requesting the grant to discharge a debt owed to the entity by another entity,
wherein the donor is not the entity requesting the grant.

2. The method of claim 1, wherein, the awarding step includes retaining by a non-profit organization a portion of the funds as a fee.

3. The method of claim 1, wherein the debt discharged in the awarding step is a down payment for a house.

4. The method of claim 1, wherein the debt discharged in the awarding step is a payment to a private school for school related expenses.

5. The method of claim 1, wherein the grant in the awarding step is used for at least one of a payment of an automobile, a medical bill, assisted care, private education, and small business administration.

6. The method of claim 1, wherein the charitable contribution in the retrieving information step is tax deductible for the donor.

7. The method of claim 1, wherein the charitable contribution in the retrieving information step is not capped for the donor.

8. The method of claim 1, further comprising:
acquiring goods or services by said another entity in exchange for the grant received by the entity requesting the grant.

9. The method of claim 8, wherein a price of the goods or services exchanged in the acquiring step is not reduced by an amount equal to the grant as awarded.

10. The method of claim 8, wherein a price of the goods or services exchanged in the acquiring step is not influenced by the grant.

11. A computer-based product storing computer instructions which can be used to program a processor to perform the following steps:
forming a pool of funds from a charitable donation made by funds from a donor and other charitable donations by other donors;
receiving a disbursement request from an entity for the grant;
retrieving information about the funds donated by the donor;
appropriating funds included in said pool of funds to the grant; and
awarding the grant to the entity requesting the grant to discharge a debt owed to the entity by another entity,
wherein the donor is not the entity requesting the grant.

12. The computer-based product as recited in claim 11, further storing instructions which can be used to program a processor to perform the following step:
retaining by a non-profit organization a portion of the funds as a fee.

13. The computer-based product as recited in claim 11, wherein the debt discharged in the awarding step is for a down payment for a house.

14. The computer-based product as recited in claim 11, wherein the debt discharged in the awarding step is for to a private school for school related expenses.

15. The computer-based product as recited in claim 11, wherein the debt discharged in the awarding step is for at least one of a payment of an automobile, a medical bill, assisted care, private education, and small business administration.

16. The computer-based product as recited in claim 11, wherein the charitable contribution in the retrieving information step is tax deductible for the donor.

17. The computer-based product as recited in claim 11, wherein the charitable contribution in the retrieving information step is not capped for the donor.

18. The computer-based product as recited in claim 11, further storing instructions which can be used to program a processor to perform the following step:
intermediating an exchange of goods or services for the grant, between the another entity and the entity requesting the grant.

19. The computer-based product as recited in claim 11, further storing instructions which can be used to program a processor to perform the following step:
maintaining a price of the goods or services exchanged between the entity requesting the grant and the another entity independent of the awarded grant.
